(19) United States
(12) Patent Application Publication
(10) Pub. No.: US 2022/0281290 A1
(43) Pub. Date: Sep. 8, 2022

(54) VEHICLE AIR-CONDITIONING CONTROLLER

(71) Applicant: TOYOTA JIDOSHA KABUSHIKI KAISHA, Toyota-shi Aichi-ken (JP)

(72) Inventors: Hidekazu Hirabayashi, Chiryu-shi Aichi-ken (JP); Takayuki Shimauchi, Toyota-shi Aichi-ken (JP)

(21) Appl. No.: 17/684,804

(22) Filed: Mar. 2, 2022

(30) Foreign Application Priority Data
Mar. 8, 2021 (JP) 2021-036187

(51) Int. Cl. B60H 1/32; B60H 1/00

(52) U.S. Cl. CPC B60H 1/3202; B60H 1/00657; B60H 2001/3255; B60H 2001/3283

(57) ABSTRACT

A vehicle air-conditioning controller includes a battery temperature sensor configured to detect a battery temperature of a battery, a cooling-air temperature sensor configured to detect a temperature of cooling air that has passed an evaporator, and an air-conditioning ECU configured to determine a target ejection temperature of air to be ejected into a vehicle interior from an air conditioner. The air-conditioning ECU is configured to control a cooling device to cool the battery, during air conditioning of the vehicle interior through remote operation external of the vehicle, when the battery temperature is at a predetermined temperature or higher and a state wherein the difference between the target ejection temperature and the cooling-air temperature has been at or below a predetermined value for a predetermined time period.

### CROSS REFERENCE TO RELATED APPLICATION

This application claims priority to Japanese Patent Application No. 2021-036187 filed on Mar. 8, 2021, which is incorporated herein by reference in its entirety including the specification, claims, drawings, and abstract.

### TECHNICAL FIELD

The present disclosure relates to a vehicle air-conditioning controller that controls, and in response to a remote operation performed externally to a vehicle, initiates operation of an air conditioner having a cooling device for cooling air within a vehicle interior and an on-vehicle battery.

### BACKGROUND

A vehicle air-conditioning controller controls an air conditioner that conditions the air within the vehicle interior and can start the air conditioner remotely or externally to a vehicle. The air conditioner includes a cooling device that cools the air within the vehicle interior and an on-vehicle battery. JP 2013-180723A, for example, discloses a vehicle air-conditioning controller that cools a battery with a cooling device at the time of starting an air conditioner through remote operation performed externally to the vehicle, thereby increasing the travel distance.

### SUMMARY

The vehicle air-conditioning controller disclosed in JP 2013-180723 A, however, cools the battery every time the air conditioner is turned on remotely, even when the vehicle interior is insufficiently cooled, and may therefore cause insufficient air-conditioning of the vehicle interior. This configuration may fail to create a comfortable vehicle interior before passengers board the vehicle. On the other hand, when only comfortability of the vehicle interior is prioritized, battery temperature may rise to a level which shortens maximum travel distance.

An embodiment of the present disclosure is therefore directed toward providing a vehicle air-conditioning controller that enables increasing the maximum travel distance while achieving a comfortable vehicle interior before occupants board.

In accordance with an aspect of the disclosure, a vehicle air-conditioning controller controls, and starts through remote operation performed externally to a vehicle, an air conditioner including a cooling device that uses a circulating refrigerant to cool the air within a vehicle interior using an evaporator and to cool an on-vehicle battery. The vehicle air-conditioning controller includes a battery temperature sensor configured to detect a battery temperature of the battery, a cooling-air temperature sensor configured to detect a temperature of cooling air that has passed through the evaporator, and a controller configured to determine a target ejection temperature of air to be ejected into the vehicle interior from the air conditioner. The controller is configured to control the cooling device to cool the battery in response to the battery temperature being a predetermined temperature or higher and the difference between the target ejection temperature and the cooling-air temperature having remained at a predetermined value or below having continued for a predetermined period of time during air conditioning of the vehicle interior through remote operation performed externally to the vehicle.

In the vehicle air-conditioning controller, when cooling the battery with the cooling device, the controller may increase the ratio of refrigerant circulated to cool the battery with respect to the amount of refrigerant circulated to cool the vehicle interior as the target ejection temperature rises.

The vehicle air-conditioning controller of the disclosure makes it possible to increase the maximum travel distance while achieving a comfortable vehicle interior.

### BRIEF DESCRIPTION OF DRAWINGS

An embodiment of the present disclosure will be described based on the following figures, wherein:

FIG. 1 schematically illustrates a vehicle according to an embodiment;

FIG. 2 schematically illustrates an air-conditioning controller;

FIG. 3 is a block diagram illustrating a configuration of an air-conditioning controller according to an example embodiment;

FIG. 4 is a graph indicating a correlation between a target ejection temperature and an allowable battery cooling level; and

FIG. 5 is a flowchart indicating a flow of air-conditioning control through externally performed remote operation.

### DESCRIPTION OF EMBODIMENTS

An example embodiment of the disclosure will be described in detail below. In the following description, specific shapes, materials, directions, and numeral values, for example, are given only as examples to facilitate understanding of the disclosure, and may be modified as appropriate in accordance with use, object, and specifications, and the like.

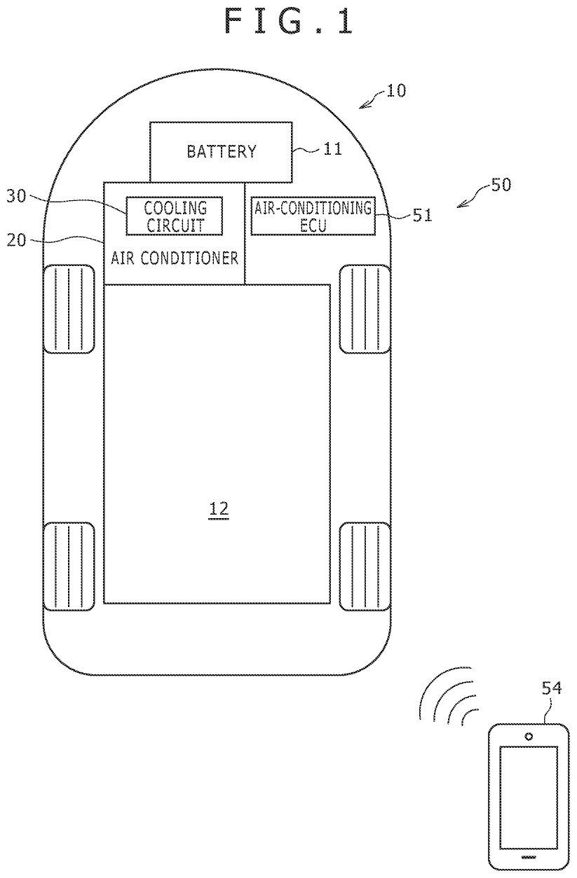

Referring to FIG. 1 which schematically illustrates a vehicle 10, the vehicle 10 including an air-conditioning controller 50 according to an example embodiment will be described.

The air-conditioning controller 50, a vehicle air-conditioning controller, illustrated in FIG. 1 is disposed in the vehicle 10. The vehicle 10 includes a battery 11 for traveling, an air conditioner 20 for air-conditioning the vehicle interior 12, and an air conditioning controller 50 including an air conditioning Electronic Control Unit (ECU) 51 that is a controller for controlling the air conditioner 20, and a smartphone 54 is used by a user to start the air conditioner 20 through remote operation. The air conditioner 20 includes a cooling circuit 30 as a cooling device for cooling the air within the vehicle interior 12 and the on-vehicle battery 11.

The vehicle 10 is an electric vehicle that travels with power of a motor, and may, for example, be a hybrid electric vehicle (HEV) that travels with power of an engine and a motor.

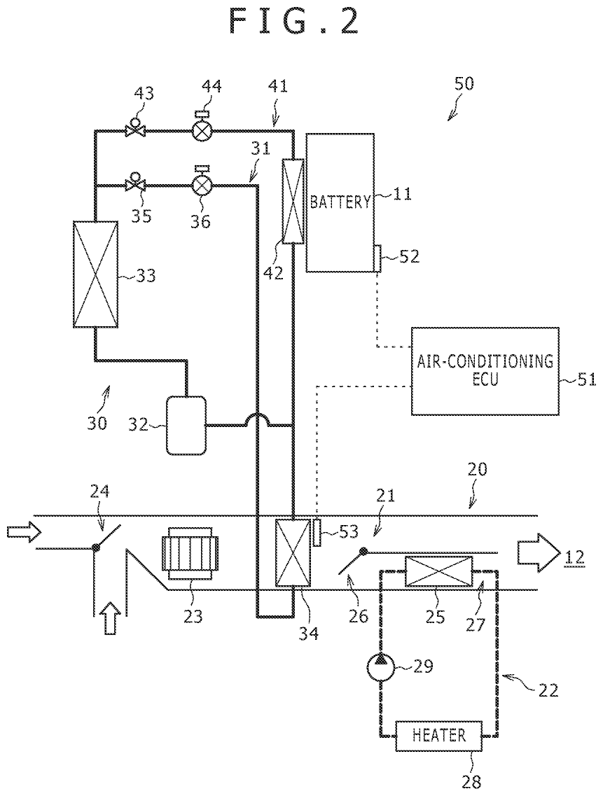

Referring to FIG. 2 which schematically illustrates the air conditioner 20, the air conditioner 20 and the cooling circuit 30 to be controlled by the air-conditioning controller 50 will be described.

As illustrate in FIG. 2, the air-conditioner 20 includes an air channel 21 through which air passes to cool and/or heat the air to be supplied to the vehicle interior 12, a heating circuit 22 for heating air to be supplied to the vehicle interior 12, and the cooling circuit 30 as a cooling device for cooling air to be supplied to the vehicle interior 12 and cooling the battery 11.

The air conditioner 20 further includes an air blower 23 that generates, in the air channel 21, an air flow toward the vehicle interior 12, an inside/outside air switching door 24 that changes between reintroduction of air from within the vehicle interior 12 (inside air) and introduction of air from outside the vehicle 10 (outside air), an evaporator 34 that is coupled to the cooling circuit 30 and evaporates refrigerant to cool the air passing through the air channel 21, and a heater core 25 that is coupled to the heating circuit 22 and heats the air passing through a heating air channel 27 which will be described below, and an air mix door 26 that opens or closes the heating air channel 27.

The heating air channel 27 is included in the middle of the air channel 21. The heater core 25 is disposed in the heating air channel 27, and the air heated by the heater core 25 passes through the heating air channel 27.

The heating circuit 22 circulates water heated by a heater 28 as a source of heat for the heater core 25 to heat the air passing through the heating air channel 27. The heating circuit 22 includes the heater 28 having an adjustable output to heat the water circulating through the heating circuit 22, the heater core 25 disposed in the heating air channel 27 to heat the air passing through the heating air channel 27 which will be described below, and a pump 29 that circulates the water through the heating circuit 22.

The cooling circuit 30 circulates refrigerant by a vapor compression refrigeration cycle to supply the refrigerant to an air cooling circuit 31 and a battery cooling circuit 41 to cool the air within the vehicle interior 12 and the battery 11, respectively. Alternatively, the cooling circuit 30 may supply the refrigerant to only either the air cooling circuit 31 or the battery cooling circuit 41 to cool one of only the air within the vehicle interior 12 or the battery 11, respectively.

The cooling circuit 30 includes a compressor 32 that compresses refrigerant gas, a condenser 33 that condenses high-temperature and high-pressure refrigerant gas ejected from the compressor 32, the air cooling circuit 31 described above, and the battery cooling circuit 41 described above.

The air cooling circuit 31, in response to a cooling request from the air conditioner 20, cools the air within the vehicle interior 12. The air cooling circuit 31 includes the evaporator 34 disposed within the air channel 21, an air cooling electromagnetic valve 35 disposed upstream of the evaporator 34 and configured to open or close the air cooling circuit 31, and an air cooing expansion valve 36 disposed upstream of the evaporator 34 and configured to regulate a circulation amount of the refrigerant to be supplied to the evaporator 34.

The battery cooling circuit 41 cools the battery 11 in response to the temperature of the battery 11 being at a predetermined temperature or higher. The battery cooling circuit 41 enables efficient cooling of the battery 11 with a refrigerant. The battery cooling circuit 41 includes a battery heat exchanger 42 disposed adjacent to the battery 11, a battery cooling electromagnetic valve 43 disposed upstream of the battery heat exchanger 42 and configured to open or close the battery cooling circuit 41, and a battery cooling expansion valve 44 disposed upstream of the battery heat exchanger 42 and configured to regulate a circulation amount of the refrigerant to be supplied to the battery heat exchanger 42.

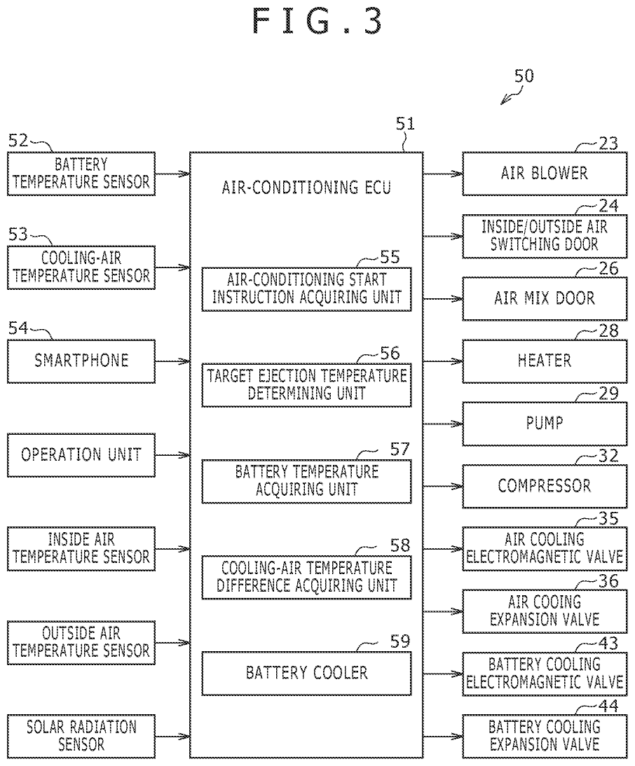

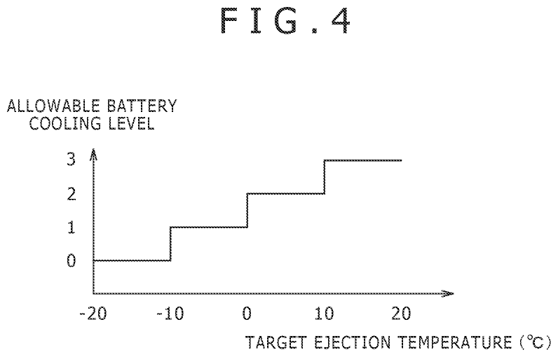

Referring now to FIGS. 2, 3, and 4, the air-conditioning controller 50 will be described. FIG. 3 schematically illustrates the configuration of the air-conditioning controller 50, while FIG. 4 is a graph showing correlation between the target ejection temperature and the allowable battery cooling level.

As illustrated in FIG. 2, the air-conditioning controller 50 controls the air conditioner 20 as described above. The air-conditioning controller 50 includes the air-conditioning ECU 51 or a control unit which will be detailed below, a battery temperature sensor 52 that detects the temperature of the battery 11, a cooling-air temperature sensor 53 that detects the temperature of cooling air having passed through the evaporator 34, the smart phone 54 that starts the air conditioner 20 through remote operation performed by a user, an operation unit that can change the set temperature (not shown), an inside-air temperature sensor (not shown), an outside air temperature sensor (not shown), and a solar radiation sensor (not shown).

As illustrated in FIG. 3, the air-conditioning ECU 51 includes a Central Processing Unit (CPU) or an operation processor, and a memory unit such as Random Access Memory (RAM) and Read Only Memory (ROM), and performs signal processing according to a program prestored in the ROM while temporarily storing data in the RAM.

The air conditioning ECU 51 is coupled with the battery temperature sensor 52, the cooling-air temperature sensor 53, the operation unit, the inside-air temperature sensor, the outside-air temperature sensor, and the solar radiation sensor, to receive signals transmitted from these components. The air conditioning ECU 51 is further coupled with the air blower 23, the inside/outside air switching door 24, the air mix door 26, the heater 28, the pump 29, the compressor 32, the air cooling electromagnetic valve 35, the air cooling expansion valve 36, the battery cooling electromagnetic valve 43, and the battery cooling expansion valve 44, to transmit signals to these components. The air-conditioning ECU 51 is further wirelessly connected with the smartphone 54 to receive signals transmitted from the smartphone 54.

The air conditioning ECU 51 includes an air-conditioning start instruction acquiring unit 55 that acquires an air-conditioning start instruction transmitted wirelessly by a user through the smart phone 54 while the vehicle is parked, a target ejection temperature determining unit 56 that determines a target temperature of the air to be ejected from the outlet of the air channel 21 into the vehicle interior 12, a battery temperature acquiring unit 57 that acquires the temperature of the battery 11 detected by the battery temperature sensor 52, a cooling-air temperature difference acquiring unit 58 that acquires a temperature difference between the target ejection temperature and the cooling-air temperature after passing through the evaporator 34 that is detected by the cooling-air temperature sensor 53 (hereinafter referred to as a cooling-air temperature difference), and a battery cooler 59 that cools the battery 11 with the battery cooling circuit 41.

The target ejection temperature determining unit 56 determines the target ejection temperature, the target temperature of the air to be ejected from the outlet of the air channel 21 into the vehicle interior 12, based on the preset temperature of the vehicle interior 12 determined by the operation unit, the inside air temperature of the vehicle interior 12 detected by the inside air temperature sensor, the outside air temperature of the vehicle 10 detected by the outside air temperature sensor, and the amount of solar radiation detected by the solar radiation sensor.

To supply air at the determined target ejection temperature, the air-conditioning ECU 51 regulates the output of the air blower 23, the degree of opening of the outside/inside air switching door 24, the degree of opening of the air mix door 26, the output of the heater 28, the output of the pump 29, the rotation rate of the compressor 32, opening and closing of the air-cooling electromagnetic valve 35, and the degree of opening of the air-cooling expansion valve 36.

The battery cooler 59 opens the battery cooling electromagnetic valve 43 and adjusts the degree of opening of the battery cooling expansion valve 44 to regulate the circulation amount of the refrigerant of the battery cooling circuit 41, thereby cooling the battery 11 so that the battery temperature detected by the battery temperature sensor 52does not exceed a predetermined temperature.

The battery cooler 59 further cools the battery 11 with the cooling circuit 30, in response to the battery temperature reaching or exceeding a predetermined temperature (50° C. in this example) and the time period in which the cooling-air temperature difference is below a predetermined temperature difference (2° C. in this example) having continued for a predetermined time (for 3 minutes in this example) or longer during air conditioning of the vehicle interior 12 performed by the air conditioner 20 after acquiring an air-conditioning start instruction by the air-conditioning start instruction acquiring unit 55.

The battery cooler 59 is allowed to cool the battery 11 in response to a cooling request for the battery 11 when the vehicle interior 12 is sufficiently cooled while the air conditioner 20 is cooling the vehicle interior 12 through externally remote operation. This configuration enables maximizing the travel distance of the vehicle 10 while achieving a comfortable vehicle interior 12 prior to occupants boarding.

When cooling the battery 11, the battery cooler 59 adjusts the battery cooling expansion valve 44 in accordance with the battery cooling level to thereby regulate the circulation of refrigerant of the battery cooling circuit 41. The battery cooling level refers to the ratio of the amount of refrigerant circulated in the battery cooling circuit 41 to cool the battery 11 with respect to the amount of refrigerant circulated in the air cooling circuit 31 to cool the vehicle interior 12.

As illustrated in FIG. 4, the allowable battery cooling level is set to be higher as the target ejection temperature rises, because, as the target ejection temperature rises, the air cooling circuit 31 becomes capable of cooling the air within the vehicle using a smaller amount of circulating refrigerant.

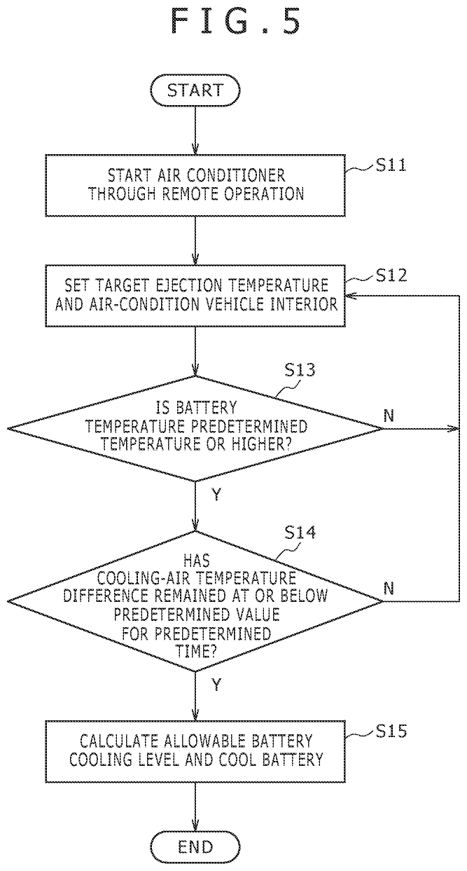

Referring to FIG. 5, a flow of air-conditioning control with external remote control will be described.

As illustrated in FIG. 5, in step S11, an air-conditioning start instruction is acquired and the air conditioner 20 is started. In step S12, a target ejection temperature is set, and the air conditioner 20 air-conditions the vehicle interior 12 to achieve the target ejection temperature. In step S13, whether the battery temperature of the battery 11 detected by the battery temperature sensor 52 is a predetermined temperature or higher is confirmed. In response to the battery temperature reaching or exceeding the predetermined temperature, the process proceeds to step S14, whereas in response to the battery temperature being below the predetermined temperature, the process returns to step S12.

In step S14, whether or not a state wherein the cooling air temperature difference is below a predetermined value has continued for a predetermined time period is confirmed. When it is determined that such a state has continued for the predetermined time period, the process proceeds to step S15, while when it is determined that such a state has not continued for the predetermined time period, the process returns to step S12.

In step S15, the allowable battery cooling level is determined in accordance with the determined target ejection temperature. The air conditioner 20 then opens the battery cooling electromagnetic valve 43, and adjusts the degree of opening of the battery cooling expansion valve 44 based on the allowable battery cooling level to regulate the circulation amount of the refrigerant to be supplied to the battery cooling circuit 41, thereby cooling the battery 11.

The present disclosure is not limited to the embodiment described above and its modification examples, and various modifications and improvements may be made within the scope of matters recited in the claims of the present application.

1. A vehicle air-conditioning controller for controlling, and starting through remote operation performed externally to a vehicle, an air conditioner, the air conditioner comprising a cooling device that cools air within a vehicle interior by circulating a refrigerant though an evaporator and also cools an on-vehicle battery with the circulating refrigerant,
the vehicle air-conditioning controller, comprising:
a battery temperature sensor configured to detect a battery temperature of the battery;
a cooling-air temperature sensor configured to detect a cooling-air temperature of cooling air that has passed through the evaporator; and
a controller configured to determine a target ejection temperature of air to be ejected from the air conditioner into the vehicle interior, wherein
the controller is configured to control the cooling device to cool the battery, during air conditioning of the vehicle interior through remote operation external to the vehicle, in response to the battery temperature being at or above a predetermined temperature and in a state wherein a difference between the target ejection temperature and the cooling-air temperature is at or below a predetermined value has continued for at least a predetermined time period.

2. The vehicle air-conditioning controller according to claim 1, wherein
in cooling the battery with the cooling device, the controller increases a ratio of an amount of refrigerant circulated to cool the battery with respect to an amount of refrigerant circulated to cool the vehicle interior as the target ejection temperature increases.
